(19) United States
(12) Patent Application Publication
(10) Pub. No.: US 2025/0024968 A1
(43) Pub. Date: Jan. 23, 2025

(54) Foldable mobile phone stand

(71) Applicant: Shuting ZHANG, Shenzhen (CN)

(72) Inventor: Shuting ZHANG, Shenzhen (CN)

(21) Appl. No.: 18/374,653

(22) Filed: Sep. 28, 2023

(30) Foreign Application Priority Data
Jul. 21, 2023 (CN) 202321934427X

(51) Int. Cl. A47F 5/12; H04M 1/04

(52) U.S. Cl. CPC A47F 5/12; H04M 1/04

(57) ABSTRACT

A foldable mobile phone stand includes a base, a supporting board and a connecting member. The base and the supporting board are rotatably connected with each other; the connecting member has a first end which is connected with the supporting board and a second end which is connected with the base; the connecting member is movably stacked between the base and the supporting board when the base and the supporting board are rotated and folded with each other. Furthermore, the base, the supporting board and the connecting member form a finger-passing hole therebetween for one finger to pass through to grip the mobile phone at ease without causing any discomfort to the hand.

### BACKGROUND OF THE INVENTION

The present invention relates to a foldable mobile phone stand.

Mobile phone stands available in the marketplace are made of metal or plastic materials, and are mainly in form of finger rings or a supporting rod for gripping by two fingers, so that users can secure the phone with their fingers. With finger rings, it is possible to use only one finger to secure the phone, but it may cause discomfort to the hand. If two fingers are used to grip the supporting rod, the two fingers need to keep gripping and thus causing fatigue easily.

### BRIEF SUMMARY OF THE INVENTION

It is an object of the present invention to overcome the above drawbacks of the prior art by providing a foldable mobile phone stand. To attain the above object, the present invention provides the following technical solutions:

A foldable mobile phone stand comprising a base, a supporting board and a connecting member; the base and the supporting board are rotatably connected with each other; the connecting member has a first end which is connected with the supporting board and a second end which is connected with the base; the connecting member is movably stacked between the base and the supporting board when the base and the supporting board are rotated and folded with each other.

Furthermore, the connecting member is a stabilizing rod; the base is provided with a limiting groove; the stabilizing rod has a first end which is rotatably connected with the supporting board and a second end which is provided with a slidable rod; the slidable rod is disposed in the limiting groove.

Furthermore, the supporting board is provided with a recess.

Furthermore, the supporting board comprises a positioning hole, a sliding slot and a positioning slot; the stabilizing rod is provided with a positioning shaft at an end thereof; the positioning shaft is configured to pass through the positioning hole to allow the stabilizing rod to move along the sliding slot so that the positioning shaft is moved to the positioning slot; the supporting board is covered with a covering board for covering the positioning slot.

Furthermore, the connecting member is made of soft material.

The beneficial effects: In the present invention, the base, the supporting board and the connecting member form a finger-passing hole therebetween for one finger to pass through to grip the mobile phone at ease without causing any discomfort to the hand.

### BRIEF DESCRIPTION OF THE DRAWINGS

In order to more clearly explain the technical solutions in the embodiments of the present invention, the following will briefly introduce the accompanying drawings used in the description of the embodiments. Obviously, the accompanying drawings in the following description are only some embodiments of the present invention; for those of ordinary skill in the art, without paying any creative labor, other drawings can be obtained based on these drawings.

FIG. 1 shows a perspective view of the mobile phone stand of the present invention.

FIG. 2 shows another perspective view of the mobile phone stand of the present invention.

FIG. 3 shows an exploded view of mobile phone stand of the present invention.

FIG. 4 shows a perspective view of another embodiment of the mobile phone stand of the present invention.

It should be noted that the accompanying drawings are not necessarily drawn in scale, but are only shown in a schematic way that does not affect readers understanding.

### DETAILED DESCRIPTION OF THE INVENTION

The following describes the technical solutions in the present invention clearly and comprehensively with reference to the accompanying drawings in the embodiments. It should be apparent that the embodiments are only some but not all of the embodiments of the present invention. All other embodiments obtained by those of ordinary skill in the art without any creative labor based on the embodiments of the present invention fall within the scope of the present invention.

In the present invention, the terms like “upper”, “lower”, “left”, “right”, “front”, “rear”, “top”, “bottom”, “inner”, “outer”, “middle”, “vertical”, “horizontal”, “lateral”, “longitudinal” and so forth indicate the orientation or positional relationship based on the orientation or positional relationship shown in the accompanying drawings, which are only for the convenience of describing the present invention and embodiments thereof, instead of limiting that the device, element or component referred to must have a specific orientation, or be constructed and operated in a specific orientation.

Moreover, the above terms may be used to indicate other meanings apart from the orientation or positional relationship. For example, the term “upper” may also be used to indicate some kind of attachment or connection in some cases. For those of ordinary skill in the art, the specific meanings of these terms in the present invention may be understood according to specific circumstances.

Besides, the terms such as “mounted”, “configured”, “provided”, “connected”, “fixed” should be understood in a broad sense; for example, the terms can refer to a fixed connection, a detachable connection, or connection as an integral component; they can refer to a mechanical connection or an electrical connection; they can refer to being directly connected, being indirectly connected through an intermediate medium, or the internal communication between two devices, elements or components. For those of ordinary skill in the art, the specific meanings of the aforementioned terms in the present invention can be understood according to specific circumstances.

Furthermore, the terms “first”, “second” and so forth are mainly used for identifying different devices, elements or components (which may be the same or different in terms of types and structures), and cannot be understood as indicating or implying relative importance and quantity of the devices, elements or components referred to. The meaning of “multiple” refers to two or more than two, unless otherwise specifically defined.

It should also be understood that the terms in the specification of the present invention are used for illustrating specific embodiments but not intended to limit the present invention. Throughout the specification and claims, the terms “a”, “one” and “the” can be realized as “one or more”, unless the context clearly dictates otherwise elsewhere.

It can also be appreciated that the term “and/or” used in the specification and claims refers to the combination and all possible combinations of one or more items listed therein, including said combinations.

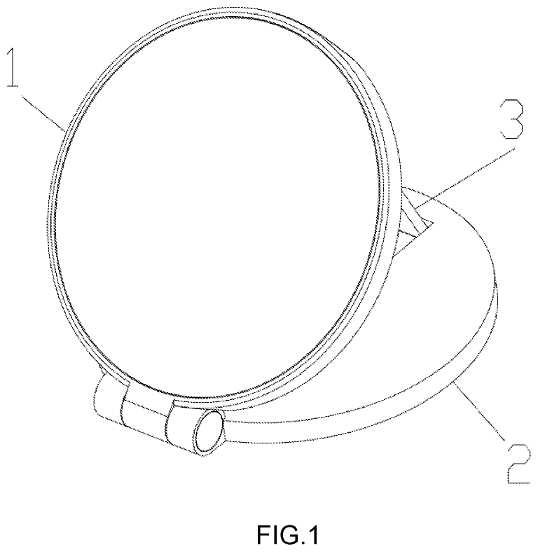

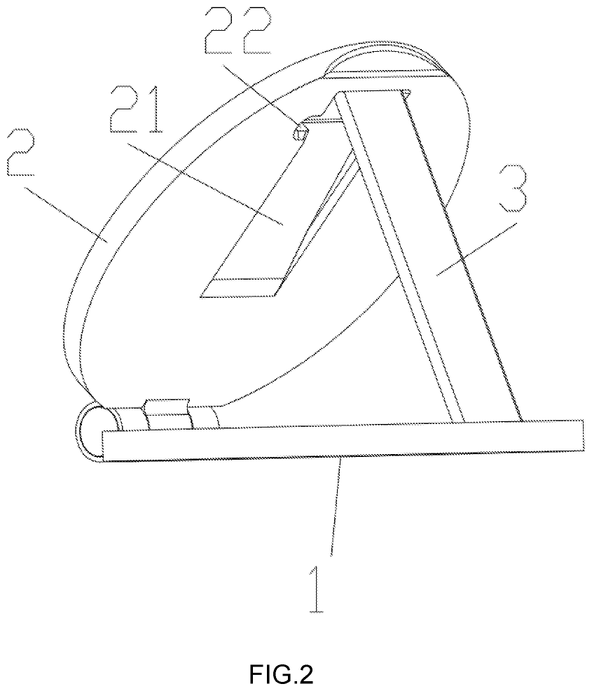

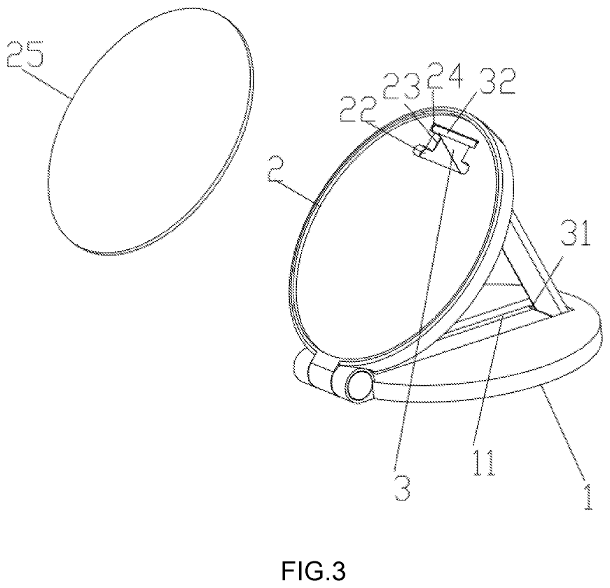

As shown in FIGS. 1 to 3, the present invention provides a foldable mobile phone stand comprising a base 1, a supporting board 2 and a stabilizing rod 3. The base 1 and the supporting board 2 are rotatably connected with each other. The base 1 is provided with a limiting groove 11. The stabilizing rod 3 has a first end which is rotatably connected with the supporting board 2 and a second end which is provided with a slidable rod 31. The slidable rod 31 is disposed in the limiting groove 31 and is slidable along the limiting groove 11.

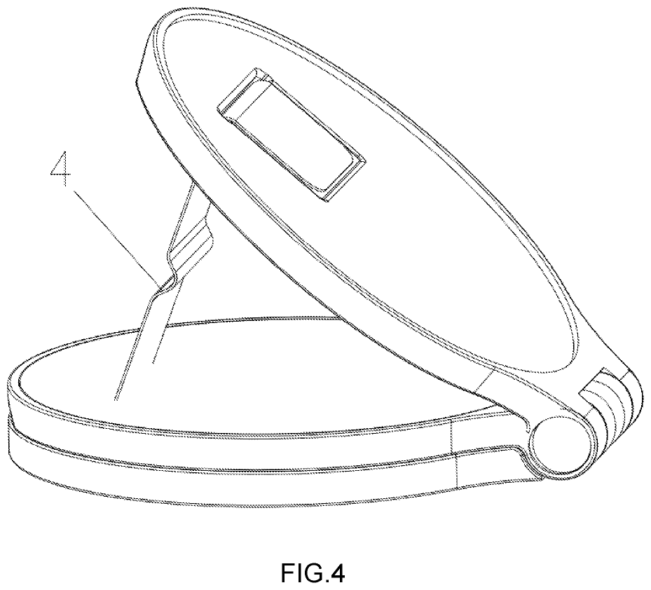

In the present invention, the mobile phone is fixed on the supporting board 1 (either by adhesives or by magnet). The base 1, the supporting board 2 and the stabilizing rod 3 form a triangular support structure. Positioning the base 1 on a table can support the mobile phone in a certain angle in a stable manner. When not in use, the base 1 is folded towards the supporting board 2 with the guidance of the slidable rod 31 and the limiting groove 11 so as to be folded on the supporting board 2. Furthermore, when the base 1, the supporting board 2 and the stabilizing rod 3 forms a triangular support structure, a finger-passing hole is formed, thereby allowing one finger to pass through to grip the mobile phone at ease without causing any discomfort to the hand. As shown in FIG. 4, the stabilizing rod may be replaced with a soft structure (such as a nylon woven rope 4), which could also form a finger-passing hole. In this embodiment, to position the mobile phone on the table stably, the base 1 and the supporting board 2 may be provided with rotation-limiting components to lock the two in position after unfolding.

In a further embodiment of the present invention, the supporting board 2 is provided with a recess 21 for receiving the stabilizing rod 3 when the base 1 and the supporting board 2 are folded, so that the supporting board 2 is completely stacked on the base 1.

In a further embodiment of the present invention, the supporting board 2 comprises a positioning hole 22, a sliding slot 23 and a positioning slot 24. The stabilizing rod 3 is provided with a positioning shaft 32 at an end thereof. The positioning shaft 32 is configured to pass through the positioning hole 22 to allow the stabilizing rod 3 to move along the sliding slot 23 so that the positioning shaft 32 is moved to the positioning slot 24. The supporting board 2 is covered with a covering board 25. The covering board 25 is used to cover the positioning slot 24. In this way, installation could be done without other tools, which brings convenience and speed.

It should be understood that, the descriptions above are only the preferred embodiments of the present invention, which are not intended to limit the present invention in any way, and the protection scope of the present invention is defined by the claims. Although the present invention is illustrated above with the preferred embodiments, equivalent changes and modifications made by those skilled in the art without departing from the essence of the present invention shall also fall within the protection scope of the present invention.

What is claimed is:

1. A foldable mobile phone stand comprising a base, a supporting board and a connecting member, wherein the base and the supporting board are rotatably connected with each other; the connecting member has a first end which is connected with the supporting board and a second end which is connected with the base; the connecting member is movably stacked between the base and the supporting board when the base and the supporting board are rotated and folded with each other.

2. The foldable mobile phone stand of claim 1, wherein the connecting member is a stabilizing rod; the base is provided with a limiting groove; the stabilizing rod has a first end which is rotatably connected with the supporting board and a second end which is provided with a slidable rod; the slidable rod is disposed in the limiting groove.

3. The foldable mobile phone stand of claim 1, wherein the supporting board is provided with a recess.

4. The foldable mobile phone stand of claim 1, wherein the supporting board comprises a positioning hole, a sliding slot and a positioning slot; the connecting member is provided with a positioning shaft at an end thereof; the positioning shaft is configured to pass through the positioning hole to allow the connecting member to move along the sliding slot so that the positioning shaft is moved to the positioning slot; the supporting board is covered with a covering board for covering the positioning slot.

5. The foldable mobile phone stand of claim 1, wherein the connecting member is made of soft material.
